(19) United States
(12) Patent Application Publication
(10) Pub. No.: US 2010/0245111 A1
(43) Pub. Date: Sep. 30, 2010

(54) END USER CONTROL OF MUSIC ON HOLD

(75) Inventors: Tomas F. Gaensler, Warren, NJ (US); James A. Johanson, Schwenksville, PA (US); Peter Kroon, Green Brook, NJ (US); Ashish Parajuli, Bethlehem, PA (US); Richard Verney, Woking (GB)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 12/303,824

(22) PCT Filed: Dec. 7, 2007
(86) PCT No.: PCT/US07/86750

§ 371 Date: Dec. 8, 2008

(51) Int. Cl. G08C 19/00

(52) U.S. Cl. 340/825.25; 340/825

(57) ABSTRACT

In an exemplary embodiment, a wireless handset allows a user having a connection in an “on-hold” state to select one or more sources for play-out of media at a handset receiver while in the on-hold state, and then be signaled when the on-hold state is terminated. Such on-hold state might be indirectly detected, such as by detection of music-on-hold, or directly detected through on-hold notification. User selected media for play-out might be locally generated at the user's handset, or provided through a separate connection established between the wireless handset and the network.

### BACKGROUND OF THE INVENTION

1. Field of the Invention

The present invention relates to communications, and, in particular, to handset features in a wireless communication system.

2. Description of the Related Art

Increasingly, users rely on a wireless handset as their principle method of accessing telecommunication services. Consequently, these users wish to have the same types of feature sets available to them in their wireless handset as they have available to them in their handset of a traditional wired-service telephone network. However, wireless communication requires many different signal processing techniques to enable service that are not present in the traditional wired-service telephone network.

One of the most typical signal processing techniques in wireless telephony is the use of compression to reduce the bandwidth and power necessary to support multiple user connections. Many techniques exist, but one commonly-used technique for voice compression is the use of speech coding. Speech coding systems often employ a speech detector, also known as a voice activity detector (VAD). The VAD examines an input signal to classify the signal as either speech or background noise. If a speech signal is detected, the speech is encoded and transmitted through the network to a receiver. If noise is detected, characteristics of the noise are measured (e.g., noise power, difference in power between speech and noise, stability, and frequency characteristics) and then occasionally transmitted to the receiver, which “reconstructs” the background noise for play-out at the receiver. Play-out of background noise at the receiver is desirable since a) it lets the listener know that the call is still connected during long periods of speech silence, and b) it prevents discontinuity in noise levels perceived by the listener when switching between voice and noise coding periods.

In addition to compression for speech coding, detection and measurement of background noise within the speech signal is employed for noise suppression, or speech enhancement, of a wireless user connection. Noise suppression employs signal processing algorithms that seek to reduce the impact of surrounding acoustic (i.e., environmental) noise to the listener's perception of a received speech signal in the downlink transmission path (e.g., base station-to-mobile unit), and, in addition, to reduce the impact of added noise from speech coding algorithms in the up-link transmission path (e.g., mobile unit-to-base station).

A common telephony feature is placing a user on “hold” or in an “on-hold” state. When a first user places a second user on hold, the connection is maintained while the first user's handset is disconnected from the connection. This allows the first user to take another call or step away from the handset. When the hold feature, or state, is enabled, the second user might be connected to another signal source for the receive signal path, such as broadcast news or a pre-recorded message. A very common signal source for the on-hold connection is pre-recorded or broadcast music, termed “music-on-hold,” where music selections are transmitted to the receiver while the connection is in an on-hold state. The music selections are played out at the second user's handset receiver until the on-hold state is terminated.

In wireless communication systems, music-on-hold presents a challenge for a system designer employing speech compression and/or noise suppression. At first, the VAD might classify the music as a speech signal, passing the signal to the receiver. But VADs often employ adaptive techniques that classify based on the relative stability of the power and frequency stability of the input signal. Consequently, the VAD might eventually re-classify the music as a background noise signal. Similarly, noise suppression algorithms have difficulty classifying music characteristics for signal processing because of the difficulty of separating the music and noise components. In one case, the music is no longer transmitted in its original form, and the corresponding “re-constructed” signal appears as noise generated at the receiver that is, in most cases, incomprehensible. This re-constructed noise has relatively high power since it is generated to match the music signal power, also making this re-constructed noise uncomfortable to listen to. In other cases, the music is transmitted, but distorted, which lowers the user's perception of call connection quality.

### SUMMARY OF THE INVENTION

In one embodiment, the present invention allows user-selected play-out of media on-hold by detecting an on-hold state for a user connection and receiving a user-selected option based on the presence of the on-hold state. The user-selected option for the on-hold state identifies play-out media inserted in a receive path signal of the user connection, and the user-selected option is implemented for the on-hold state

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a flowchart of an exemplary method of user-selected play-out of media on-hold in accordance with embodiments of the present invention;

FIG. 2 shows a network that might employ the exemplary method of FIG. 1.

### DETAILED DESCRIPTION

In accordance with exemplary embodiments of the present invention, a handset (e.g., a wireless handset) allows a user having a connection in an on-hold state to select one or more sources for play-out of media at the handset receiver while the user is placed in the on-hold state by another party. In some embodiments, the handset then signals the user i) when the on-hold state is terminated and/or ii) when a transition occurs to the off-hold state with active user inter-connection in transmit and receive paths. In some embodiments, actions taken when the on-hold/off-hold transitions occur might occur interactively through menu display and keypad entry on the handset by the user. In other embodiments, the actions taken when the on-hold/off-hold transitions occur might be pre-programmed/provisioned by the user to occur automatically. Such on-hold state might be detected through on-hold notification of, for example, out-of-band signaling information, direct input from the wireless handset user placed in the on-hold state, or monitoring of the voice channel itself by audio processing at the handset, such as by the detection of music in the voice channel when placed in a music-on-hold condition. User-selected media for play-out might be locally generated at the user's handset, or provided through a separate connection established between the handset and the network.

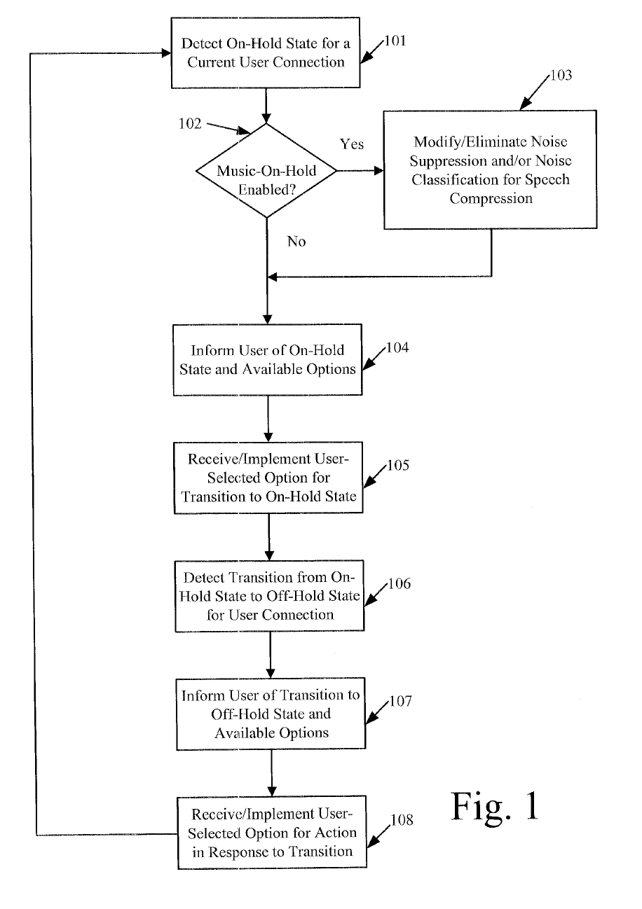

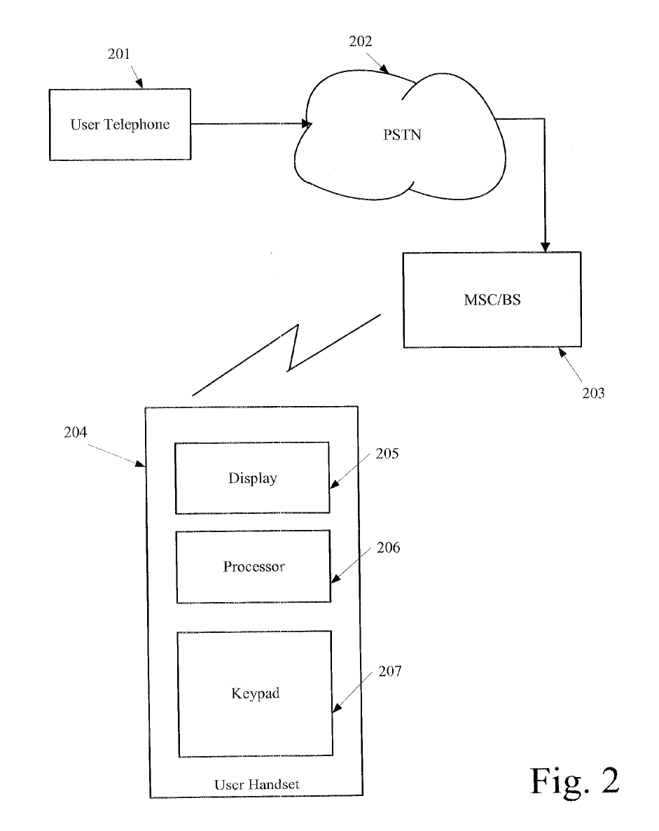

FIG. 1 shows a flowchart of an exemplary method of user-selected play-out of media on-hold in accordance with certain embodiments of the present invention. As employed herein, user-selected play-out of media refers, in general, to the handset user selecting the source for the media that is played out to the handset user in the receive path of the connection while the handset user is placed in the on-hold state. FIG. 2 shows a network that might employ the exemplary method of FIG. 1. In FIG. 2, a user of user telephone 201 is in communication with a user of wireless handset 204 through public switched telephone network (PSTN) 202 and MSC/BS 203. Wireless handset 204 includes display 205, keypad (data entry sensor) 207, and processor 206 that might implement the exemplary method of FIG. 1.

At step 101 of FIG. 1, processor 206 of wireless handset 204 monitors at least one of i) the out-of-band call connection information; ii) the in-band signal (e.g., music), and iii) user input data for an active user connection to determine if the user connection is in an on-hold state. If, at step 101, no on-hold state is detected, the method continues to monitor the active user connection (i.e., the method remains at step 101).

Methods are known in the art to detect whether a connection is in an on-hold state, and may either be direct or indirect, where direct methods might use call connection information in a logical channel outside of the received voice channel, while indirect methods might use audio processing of the received signal in the voice channel. For example, direct methods of on-hold state detection might employ signaling by the network to the user placed in the on-hold state. Such method is described in U.S. Pat. No. 6,219,415 to Deutsch et al., incorporated by reference herein in its entirety (“Deutsch”). As described in Deutsch, telecommunication systems typically communicate on-hold state information between users out of band through the signaling system (e.g., signaling system seven (SS7)). In a wireless network, the downlink channels might include such on-hold state information along with other similar types of connection state information (e.g., on-hook/off-hook, call waiting).

Indirect methods of on-hold state detection might examine the signal received by the user. For example, the handset receiver might be configured for detection of music-on-hold, thus indicating to the user that the connection is in an on-hold state. Many techniques exist in the art for detection of music-on-hold. One such method is described in U.S. Pat. No. 7,120,576 to Gao, incorporated by reference herein in its entirety (“Gao”). Preferred embodiments of the present invention employ direct methods, such as out-of-band signaling, to determine whether the connection is in an on-hold state as direct methods might be more reliable than algorithms that attempt to classify or detect certain in-band signals, such as music.

Returning to FIG. 1, if, at step 101, an on-hold state is detected, an optional test 102 determines if the on-hold state is enabled with a music-on-hold feature initiated at a network end of the user's connection. The network end of the user's connection might include equipment of the other party to the user's connection (e.g., user telephone 201), or any equipment within the telephone network (e.g., PSTN 202) servicing the connection up to the mobile switching center (MSC) or base station (BS) serving the wireless leg of the user connection between the user's wireless handset and the MSC/BS.

If optional test 102 determines that the on-hold state is enabled with a music-on-hold feature, then optional step 103 might be invoked by the processor of the user's wireless handset to inform the MSC/BS that user's connection is placed in a music-on-hold state and that modification of noise suppression techniques employed within the downlink to the wireless handset is required. Modification of the noise suppression techniques might include reducing noise suppression to a minimal level or turning noise suppression off entirely. In addition, optional step 103 might inform the MSC/BS that user's connection should not employ speech/noise classification in the downlink to generate noise packets for speech compression. Steps 102 and 103 might also be employed for other on-hold features, such as advertising or broadcast information. Reduction or elimination of noise suppression also improves the quality of these connections as well.

If optional test 102 and step 103 are not employed or if optional test 102 determines that the on-hold state is not enabled with a music-on-hold feature, the method advances to step 104. At step 104, the user is informed that the user connection is in an on-hold state. A processor of the wireless handset implementing the exemplary method of FIG. 1 might inform the user through an audio or visual technique, such as through causing a unique sound or light to be produced, or the processor might, for example, provide the user with a menu of options available during the on-hold state of the user connection through a display. At step 105, the method receives and implements the user-selected option in response to the on-hold state indication. Such receipt of the user-selected option might be through voice-command recognition, sense (detection by sensor) of keypad entries, or through sense of touch screen indicators on the display.

Options available to the user include locally-generated (those implemented by processor and associated circuitry at the receiver handset) and network-enabled (those implemented in coordination with the external communication network) signal sources or media inserted into the receive signal path of the user connection at the wireless handset while in the on-hold state. For example, the menu might allow the user to select locally generated signal sources or pre-recorded information such as music, video, or voice (e.g., dictation information) to be played out at the wireless handset while in the on-hold state. The menu might allow the user to select network-enabled signal sources or information such as music/video, e-mail, internet, network broadcast channels, or other network streaming media inserted into the receive signal path at the MSC/BS. Alternatively, the menu might allow the user just to have only an indication when the transition from the on-hold state to the off-hold state occurs.

At step 106, the transition from on-hold state to off-old state is detected, and, at step 107, the user is informed. The user might be informed by, for example, ringing, vibration, or menu pop-up on a user interface display of the wireless handset. At step 108, the method receives and implements the user-selected option in response to the off-hold state indication. The user may optionally choose to i) place the user connection in a continued on-hold state while finishing a current activity, ii) terminate the user connection, or iii) return to the user connection in the off-hold state. The method then returns to step 101 for either the current or next user connection.

While the exemplary embodiment of the present invention described with respect to FIGS. 1 and 2 describes a method operating interactively with a user of a wireless handset, the present invention is not so limited. A wireless handset user might have available in the wireless handset the ability to program certain actions described with respect to the exemplary embodiments to occur automatically. For example, the user might program, or provision, the handset to automatically select stored music or a pre-defined streaming media data source to be substituted into the voice channel during the period of the on-hold state without having to respond to menu-driven options each time an on-hold state is detected. Note that the user who provisions a handset might not necessarily be the user of the handset implementing an embodiment of the present invention during a call connection.

While the present invention is described with respect to embodiments related to wireless handsets, the present invention is not so limited. For example, the present invention might be implemented in cordless handsets, voice-over-internet protocol (VoIP) handsets, or in handsets of other telephony systems where on-hold and off-hold states are present.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

We claim:

1. A method of user-selected play-out of media on-hold, the method comprising:
detecting an on-hold state for a user connection;
receiving a user-selected option based on the presence of the on-hold state, wherein the user-selected option for the on-hold state identifies play-out media inserted in a receive path signal of the user connection; and
implementing the user-selected option for the on-hold state.

2. The invention of claim 1, further comprising the step of:
detecting a transition from the on-hold state to an off-hold state for the user connection.

3. The invention of claim 2, further comprising the step of:
implementing a user-selected option for the off-hold state automatically based on user provisioning, wherein the user-selected option for the off-hold state identifies at least one of i) termination and ii) continuation of play-out media in the receive path signal of the user connection.

4. The invention of claim 2, further comprising the steps of:
indicating the transition to the off-hold state to the user;
receiving a user-selected option based on the indicated transition to the off-hold state, wherein the user-selected option for the off-hold state identifies at least one of i) termination and ii) continuation of play-out media in the receive path signal of the user connection; and
implementing the user-selected option for the off-hold state.

5. The invention of claim 1, wherein the step of detecting the on-hold state comprises the steps of:
monitoring the receive path signal; and
detecting music-on-hold for the receive path signal.

6. The invention of claim 5, further comprising the step of requesting modification of transmission of the signal in the receive path during the music-on-hold.

7. The invention of claim 6, wherein the step of requesting modification of transmission of the signal in the receive path during the music-on-hold modifies noise suppression within the receive path.

8. The invention of claim 6, wherein the step of requesting modification of transmission of the signal in the receive path during the music-on-hold modifies noise classification of speech coding in the receive path.

9. The invention of claim 1, wherein the step of detecting the on-hold state comprises the steps of:
monitoring information in an out-of-band signaling path for the user connection; and
detecting the on-hold state in the information of the out-of-band signaling path.

10. The invention of claim 1, wherein, for the step of receiving the user-selected option based on the presence of the on-hold state, the play-out media inserted in the receive path signal of the user connection comprises at least one of a locally generated signal source and a network-enabled signal source.

11. The invention of claim 1, further comprising the steps of indicating the presence of the on-hold state to a user and receiving, at a sensor, the user-selected option for the on-hold state.

12. The invention of claim 1, wherein the step of implementing the user-selected option for the on-hold state occurs automatically based on user provisioning.

13. Apparatus for user-selected play-out of media on-hold, the apparatus comprising
a processor adapted to i) detect an on-hold state for a user connection; and
a sensor adapted to receive a user-selected option based on the presence of the on-hold state, wherein the user-selected option for the on-hold state identifies play-out media inserted in a receive path signal of the user connection,
wherein the processor is further adapted to implement the user-selected option for the on-hold state.

14. The invention of claim 13, wherein the processor detects a transition from the on-hold state to an off-hold state for the user connection.

15. The invention of claim 14, wherein the processor implements a user-selected option for the off-hold state automatically based on user provisioning, and wherein the user-selected option for the off-hold state identifies at least one of i) termination and ii) continuation of play-out media in the receive path signal of the user connection.

16. The invention of claim 14, wherein:
the processor indicates the transition to the off-hold state to the user;
the sensor receives a user-selected option based on the indicated transition to the off-hold state;
the user-selected option for the off-hold state identifies at least one of i) termination and ii) continuation of play-out media in the receive path signal of the user connection; and
the processor implements the user-selected option for the off-hold state.

17. The invention of claim 13, wherein the processor monitors the receive path signal and detects music-on-hold for the receive path signal.

18. The invention of claim 17, wherein the processor requests modification of transmission of the signal in the receive path during the music-on-hold.

19. The invention of claim 18, wherein the processor requests modification of transmission of the signal in the receive path during the music-on-hold to modify noise suppression within the receive path.

20. The invention of claim 18, wherein the processor requests modification of transmission of the signal in the receive path during the music-on-hold to modify noise classification of speech coding in the receive path.

21. The invention of claim 13, wherein the processor monitors information in an out-of-band signaling path for the user connection; and detects the on-hold state in the information of the out-of-band signaling path.

22. The invention of claim 13, wherein the play-out media inserted in the receive path signal of the user connection comprises at least one of a locally generated signal source and a network-enabled signal source.

23. The invention of claim 13, further comprising the steps of indicating the presence of the on-hold state to a user and receiving, at a sensor, the user-selected option for the on-hold state.

24. The invention of claim 13, wherein the processor implements the user-selected option for the on-hold state occurs automatically based on user provisioning.

25. The invention of claim 13, wherein the apparatus is a wireless handset.
